(19) United States
(12) Patent Application Publication
(10) Pub. No.: US 2006/0124666 A1
(43) Pub. Date: Jun. 15, 2006

(54) Vacuum device

(76) Inventor: Nobuyuki Takahashi, Sagamihara (JP)

Correspondence Address: WENDEROTH, LIND & PONACK, L.L.P., 2033 K STREET N. W., SUITE 800, WASHINGTON, DC, 20006-1021, US

(21) Appl. No.: 11/302,378

(22) Filed: Dec. 14, 2005

(30) Foreign Application Priority Data
Dec. 15, 2004 (JP) 2004-362586

(51) Int. Cl. B67D 5/52

(52) U.S. Cl. 222/135

(57) ABSTRACT

The present invention is, in a vacuum device which comprises at least a plurality of vacuum containers which are located in series via gate valves, at least one carrier located in the vacuum containers and movable between the vacuum containers, a first exhaust mechanism connected to the vacuum containers, a vacuum forming mechanism connected to the vacuum containers and a gas supplying mechanism for supplying gas to the vacuum containers, the invention is that the vacuum forming mechanism comprises a vacuum pump and an intermediate container between the vacuum pump and the vacuum containers.

### BACKGROUND OF THE INVENTION

The present invention relates to a device using vacuum like a sputtering device, especially a vacuum device in which a plurality of vacuum containers are installed.

JP 57-63677 A1 discloses a sequence vacuum processor that the objection thereof is to intend to make flow process of a vacuum process such as sputtering and a process before and after it smooth, and in that pretreated substitutes are accumulated in the atmosphere side of a before stage of an insertion room and a subsidiary container to transfer the substrates to the insertion room; and the vacuum treated substrates in the vacuum are accumulated in the atmosphere side of the latter stage of a take-out room, and a subsidiary container to transfer the substrates post-treated process.

JP 63-157870 A1 discloses a substrate processing device that a plurality of substrate processing chambers (including input/output chambers) each of which is an exhaust system independently are arranged via gate valves around separation chambers having independent exhaust systems respectively, that gate valves installed between the substrate processing chambers and the separation chambers respectively have possibility for insulating between the substrate processing chambers and the separation chambers respectively completely, and that is constituted so that: when one gate valve is opened, the other gate valves are always closed, and the other gate valves are opened after a certain delay time from when the one gate valve is closed.

JP 7-126849 A1 discloses a load lock device in which a carry-in portion or a carry-out portion for processing objection in a vacuum processing device are installed in succession, wherein a plurality of vacuum chambers connected with roughing vacuum systems are arranged in succession via gate valves possible to form a transportation route for processing objections.

In the above mentioned JP 57-63677 A1, it is disclosed that the exhaust pumps are provided to the insertion room, the sputtering room and taking-out room respectively, and in the above mentioned JP 63-157870 A1, it is disclosed that the plural substrate processing chambers have independent exhaust systems respectively. Besides, in JP 7-126849 A1, it is disclosed that the load lock device which comprises a plurality of vacuum chambers before and after the sputtering chamber for sputtering in succession, that this load lock device is constituted of the plural vacuum chambers, that a vacuum exhaust pump is connected to a loading chamber before the sputtering chamber, and that the roughing vacuum pump (a rotary pump) is connected to a vacuum chamber before the loading chamber.

However, because a vacuum chamber itself is desired to be miniaturized as a processing substitute is miniaturized and every vacuum chamber has an independent exhaust system, there is a problem such as to limit the miniaturization. Furthermore, because a price of the processing substitute itself is decreased as the miniaturization of the processing substrate, it is necessary to decrease costs of the facilities.

### BACKGROUND OF THE INVENTION

The present invention is to provide a vacuum container which can maintain ability of the vacuum device itself and can decrease the number of parts for forming vacuum.

Accordingly, in a vacuum device which comprises at least a plurality of vacuum containers which are located in series via gate valves, at least one carrier located in the vacuum containers and movable between the vacuum containers, a first exhaust mechanism connected to the vacuum containers, a vacuum forming mechanism connected to the vacuum containers and a gas supplying mechanism for supplying gas to the vacuum containers, the invention is that the vacuum forming mechanism comprises a vacuum pump and an intermediate container between the vacuum pump and the vacuum containers.

Furthermore, the vacuum forming mechanism comprises connection portions connected between the intermediate container and the vacuum containers, wherein each of the connection portions a pipe connected between the intermediate container and the corresponding vacuum container and an on-off valve for opening and closing the pipe.

According to the present invention, vacuuming of every vacuum container can be performed by only one pump while an influence to degree of vacuum in every vacuum container which is disadvantage due to vacuuming by only one pump can be restricted, so that miniaturization of the vacuum device is achieved and costs of the facilities can be decreased. Moreover, thus, profitability can be increased.

### BRIEF DESCRIPTION OF THE DRAWING

FIG. 1 is a schematic diagram of a vacuum device according to an embodiment of the present invention.

### BEST MODE FOR CARRYING OUT THE INVENTION

Hereinafter, we explain an embodiment of the present invention by referring the drawing.

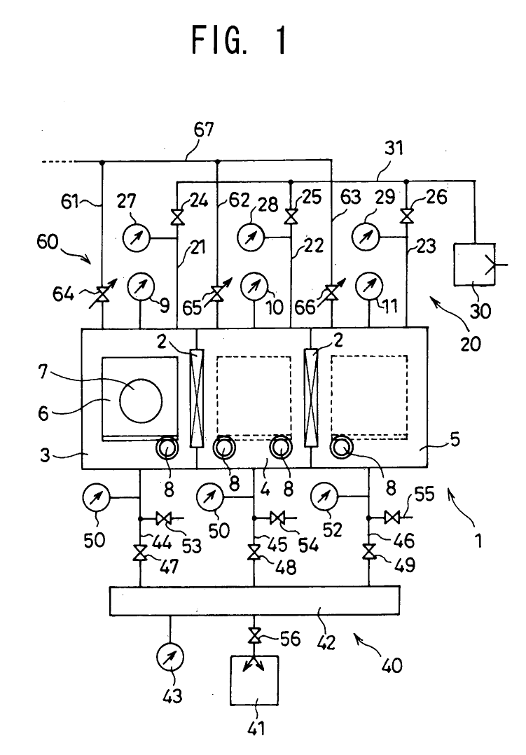

A vacuum device 1 according to the embodiment of the present invention is, for instance, shown in FIG. 1. The vacuum device 1 comprises a plurality of vacuum containers 3, 4 and 5 arranged in series via gate valves 2, at least one carrier 6 movable between the vacuum containers 3, 4 and 5, a first exhaust mechanism 20 connected to the vacuum containers 3, 4 and 5, a vacuum forming mechanism 40 connected to the vacuum containers 3, 4 and 5, and a gas supplying mechanism for supplying processing gas such as sputtering gas.

In the vacuum containers 3, 4 and 5, for instance, processing such as sputtering, dry-etching, CVD and the like is performed. Accordingly, in the case that the processing is performed independently in every vacuum container 3, 4 and 5, the vacuum containers 3, 4 and 5 are cut off one anther by closing the gate valves and carriers 6 installing a substrates 7 are located in the vacuum containers 3, 4 and 5, respectively. Besides, when different processing is performed to the substrate 7 in series, by opening the gate valve 2 between vacuum containers 3 and 4, the carrier 6 installing the substrate which is processed, for instance, in the vacuum container 3 is transported to the next vacuum container 4 by means of a transportation mechanism 8 to perform the processing in the vacuum container 4 different from in the vacuum container 3, and further the carrier 6 installing the substrate which is processed in the vacuum container 4 is transported to the next vacuum container 5 by means of a transportation mechanism 8 to perform the processing in the vacuum container 5 different from in the vacuum container 4. Thus, consequence processing can be performed in the vacuum containers 3, 4 and 5. Furthermore, vacuum gauges 9, 10 and 11 for measuring degree of vacuum are provided in the vacuum containers 3, 4 and 5, respectively.

The first exhaust mechanism 20 is constituted of at least an exhausting pump 30, a common pipe 31 extending from the pump 30, branching pipes 21, 22 and 23 connected between the vacuum containers 3, 4 and 5 and the common pipe 31 respectively, on-off valves for opening and closing the branching pipes 21, 22 and 23, and pressure gauges 27, 28 and 29 for detecting exhausting conditions in the vacuum containers 3, 4 and 5 by the exhausting pump 30. Thus, after the carrier 6 installing the substrate 7 is located in the vacuum containers 3, 4 and 5, pressure in the selected vacuum containers 3, 4 and 5 can be decreased to a specific pressure (for instance, about 10 Pa) as a stage before vacuuming.

The vacuum forming mechanism 40 is constituted of a vacuum pump 41 such as a cryopump, an intermediate vacuum container 42 connected to the vacuum pump 41 via an on-off valve 56, pipes 44, 45 and 46 connected between the intermediate vacuum chamber 42 and the vacuum chambers 3, 4 and 5, on-off valves 47, 48 and 49 for opening and closing the pipes 44, 45 and 46 respectively, and vacuum gauges 50, 51 and 52 for detecting vacuuming conditions in the vacuum containers respectively. Furthermore, leak valves 53, 54 and 55 for connecting between the vacuum containers 3, 4 and 5 and the air are provided in the pipes 44, 45 and 46, respectively. Besides, a pressure gauge 43 for detecting pressure is provided in the intermediate vacuum container 42. The vacuum chambers 3, 4 and 5 which were decreased to the specific pressure by the first exhausting mechanism 20 are vacuumed to a vacuum condition of about 1×10⁻⁴ Pa by the vacuum forming mechanism 40.

The gas supplying mechanism 60 is constituted of a common pipe 67 connected to a gas tank not shown in the figure, branching pipes 61, 62 and 63 connected between the common pipe 67 and the vacuum containers 3, 4 and 5 respectively, and variable fluid valves 64, 65 and 66 which can adjust opening level of the branching pipes 61, 62 and 63. Besides, the gas installed in the gas tank is argon gas or the like as a sputtering gas. Thus, the gas adjusted by the variable fluid valve 64, 65 or 66 is filled up into a specific vacuum container 3, 4 or 5 vacuumed by the vacuum forming mechanism 40 to a specific value (for instance, 1 Pa) to perform the processing.

As explained above, in the vacuum device 1, as a vacuum exhausting system of the vacuum containers 3, 4 and 5 can be performed by only one pump 41, the number of parts thereof can be decreased. Besides, in the case that the plural vacuum containers 3, 4 and 5 are vacuumed by the vacuum pump 41 simultaneously, when the vacuum conditions in the plural vacuum containers 3, 4 and 5 are different from one another, the vacuum conditions become unstable. However, because the intermediate vacuum container 42 is provided, stability of the vacuum conditions in the vacuum containers 3, 4 and 5 can be designed.

What is claimed is:

1. A vacuum device comprising:
a plurality of vacuum containers arranged in series via gate valves;
a first exhausting mechanism connected to said vacuum containers respectively;
a vacuum forming mechanism connected to said vacuum containers respectively; and
a gas supplying mechanism for supplying gas to said vacuum containers respectively;
wherein said vacuum forming mechanism is provided with a vacuum pump and an intermediate container between said vacuum pump and said vacuum containers respectively.

2. A vacuum device according to claim 1, wherein:
said vacuum forming mechanism is further provided with connecting portions connected between said intermediate vacuum container and said vacuum containers respectively, and
each of said connecting portions has a pipe connected between said intermediate container and the responding vacuum container respectively and an on-off valve for opening and closing the responding pipe.

3. A vacuum device according to claim 1, wherein said first exhaust mechanism is constituted of at least:
an exhausting pump;
a common pipe extending from said exhausting pump;
branching pipes connected between the vacuum containers;
said common pipe respectively, on-off valves for opening and closing the branching pipes; and
pressure gauges for detecting exhausting conditions in said vacuum containers by said exhausting pump.

4. A vacuum device according to claim 2, wherein said first exhaust mechanism is constituted of at least:
an exhausting pump;
a common pipe extending from said exhausting pump;
branching pipes connected between the vacuum containers;
said common pipe respectively, on-off valves for opening and closing the branching pipes; and
pressure gauges for detecting exhausting conditions in said vacuum containers by said exhausting pump.

5. A vacuum device according to claim 1, wherein said gas supplying mechanism is constituted of at least:
a common pipe connected to a gas tank;
branching pipes connected between the common pipe and the vacuum containers respectively; and
variable fluid valves which can adjust opening level of the branching pipes.

6. A vacuum device according to claim 2, wherein said gas supplying mechanism is constituted of at least:
a common pipe connected to a gas tank;
branching pipes connected between the common pipe and the vacuum containers respectively; and
variable fluid valves which can adjust opening level of the branching pipes.

7. A vacuum device according to claim 3, wherein said gas supplying mechanism is constituted of at least:
a common pipe connected to a gas tank;
branching pipes connected between the common pipe and the vacuum containers respectively; and
variable fluid valves which can adjust opening level of the branching pipes.

8. A vacuum device according to claim 4, wherein said gas supplying mechanism is constituted of at least:
a common pipe connected to a gas tank;
branching pipes connected between the common pipe and the vacuum containers respectively; and
variable fluid valves which can adjust opening level of the branching pipes.
